(19) United States
(12) Patent Application Publication
(10) Pub. No.: US 2014/0108136 A1
(43) Pub. Date: Apr. 17, 2014

(54) AUGMENTED REALITY FOR SHIPPING

(71) Applicants: Peng Zhao, San Jose, CA (US); Jennifer Ihrie, Los Altos, CA (US); Margaret Szeto, Mountain View, CA (US); Kevin Wook Lee, San Ramon, CA (US)

(72) Inventors: Peng Zhao, San Jose, CA (US); Jennifer Ihrie, Los Altos, CA (US); Margaret Szeto, Mountain View, CA (US); Kevin Wook Lee, San Ramon, CA (US)

(73) Assignee: eBay Inc., San Jose, CA (US)

(21) Appl. No.: 13/686,292

(22) Filed: Nov. 27, 2012

Related U.S. Application Data
(60) Provisional application No. 61/713,380, filed on Oct. 12, 2012.

(51) Int. Cl. G06Q 50/28

(52) U.S. Cl. CPC G06Q 50/28; G06Q 10/0833
USPC 705/14.49; 705/330; 705/333

(57) ABSTRACT

A system, computer-readable storage medium storing at least one program, and computer-implemented method for providing augmented reality shipping features is provided. A parcel is identified based on input received from a user. Presentation data including content having interactive elements specific to the parcel is generated. The presentation data is transmitted to a client device. The client device is instructed to overlay the presentation data on an image of the parcel.

### RELATED APPLICATIONS

This application claims the benefit under 35 U.S.C. 119(e) of U.S. Provisional Patent Application Ser. No. 61/713,380 filed Oct. 12, 2012, which is incorporated herein by reference in its entirety and made a part hereof.

### TECHNICAL FIELD

Example embodiments of the present application generally relate to image recognition, and more particularly, to a system and method for enhanced digital content using augmented reality.

### BACKGROUND

Augmented Reality (AR) provides a view of a physical, real-world environment whose elements are augmented by computer-generated sensory input such as sound, video, graphics, or GPS data. AR may provide users with the ability to interact and digitally manipulate information about the surrounding real world. AR technology allows for artificial information about a real-world environment and its objects to be overlaid on the real world.

### BRIEF DESCRIPTION OF THE DRAWINGS

Some embodiments are illustrated by way of example and not limitation in the figures of the accompanying drawings in which:

FIG. 1 is a block diagram illustrating an environment for operating a mobile device, according to an example embodiment.

FIG. 2 is a diagrammatic representation of a label used in providing augmented reality services for a parcel, according to some embodiments.

FIG. 3 is a diagrammatic representation of an example mobile device and a parcel having a label used in providing augmented reality service, according to some embodiments.

FIG. 4 is a flowchart illustrating an example method for providing augmented reality enhanced shipping label services, according to an example embodiment.

FIG. 5A is an interface diagram illustrating an example augmented reality service user interface displaying a message to a parcel recipient, according to some embodiments.

FIG. 5B is an interface diagram illustrating an example augmented reality service user interface displaying a message to a parcel recipient, according to some embodiments.

FIG. 6A is an interface diagram illustrating an example augmented reality service user interface displaying a prompt to confirm shipment, according to some embodiments.

FIG. 6B is an interface diagram illustrating an example augmented reality service user interface displaying a notification of confirmation of shipment, according to some embodiments;

FIG. 7 is a block diagram illustrating a mobile device, according to an example embodiment.

FIG. 8 is a diagrammatic representation of a machine in the example form of a computer system within which a set of instructions for causing the machine to perform any one or more of the methodologies discussed herein may be executed.

### DETAILED DESCRIPTION

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense

Aspects of the present disclosure describe a shopping and shipping experience that incorporates augmented reality (AR) technology. In some embodiments, unique, machine-readable identification objects are generated and printed on a shipping label, packing slip or parcel packaging. The identification object may be a texture object, bar code, quick response (QR) code, or alphanumeric sequence (e.g., shipment tracking number) that identifies a parcel and associated AR content. The recipient of the parcel uses a mobile application, which includes image recognition capabilities, to read the identification objects and engage with an electronic commerce provider or user-customized features via augmented reality experiences. The recipient can confirm delivery, view a greeting card sent by the buyer for gift packages, and receive communications such as brand campaigns and coupons.

In some embodiments, a seller may add customized augmented reality features to a shipping label or other piece of printed content. In another embodiment, the buyer may purchase an augmented reality service as part of a checkout flow for the purchase of an item. In this embodiment, the seller may provide a shipping label that is enabled to provide augmented reality features in order to deliver the package in accordance with customer expectations.

### Example Operating Environment and System

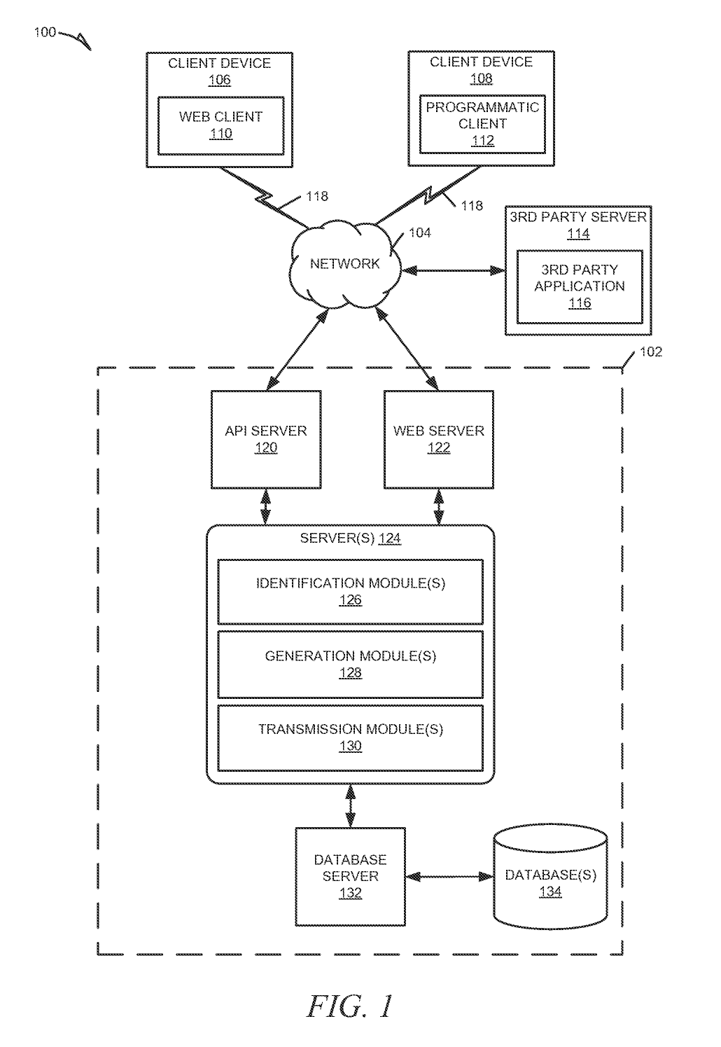

FIG. 1 is a network diagram depicting a network system 100, according to one embodiment, having a client-server architecture configured for exchanging data over a network. For example, the network system 100 may be a publication/publisher system 102 where clients may communicate and exchange data within the network system 100. The data may pertain to various functions (e.g., shipping confirmation) and aspects (e.g., managing content) associated with the network system 100 and its users.

A data exchange platform, in an example form of a network-based publisher 102, may provide server-side functionality, via a network 104 (e.g., the Internet), to one or more client devices. The one or more client devices may be operated by users that use the network system 100 and more specifically, the network-based publisher 102, to exchange data over the network 104. These transactions may include transmitting, receiving (communicating) and processing data to, from, and regarding content and users of the network system 100. The data may include, hut are not limited to, content and user data such as image data; product and service reviews; product, service, manufacture, and vendor recommendations and identifiers; product and service listings associated with buyers and sellers; product and service advertisements; visualization data; parcel shipping data; auction bids; and transaction data, among other things.

In various embodiments, the data exchanges within the network system 100 may be dependent upon user-selected functions available through one or more client or user interfaces (UIs). The UIs may be associated with a client device, such as a client device 106 using web client 110. The web client 110 may be in communication with the network-based publisher 102 via a web server 122. The UIs may also be associated with a client device 108 using a programmatic client 112, such as a client application, or a third party system 114 (e.g., one or more servers or client devices) hosting a third party application 116. It can be appreciated that, in various embodiments, the client device 106, 108, and/or the third party system 114 may be associated with a buyer, a seller, a third party electronic commerce platform, a payment service provider, or a shipping service provider, each in communication with the network-based publisher 102 and optionally each other. The buyers and sellers may be any one of individuals, merchants, or service providers, among other things.

The client devices 106 and 108 may be any of a variety of types of devices (for example, a cellular telephone, a personal digital assistant (PDA), a Personal Navigation Device (PND), a handheld computer, a tablet computer, a notebook computer, or other type of movable device). The client devices 106 and 108 may interface via a connection 118 with a communication network 104 (e.g., the Internet or WAN). Depending on the form of the client device 106 and 108, any of a variety of types of connections 118 and communication networks 104 may be used.

For example, the connection 118 may be Code Division Multiple Access (CDMA) connection, a Global System for Mobile communications (GSM) connection, or other type of cellular connection. Such connection 118 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 104 may include a cellular network that has a plurality of cell sites of overlapping geographic coverage, interconnected by cellular telephone exchanges. These cellular telephone exchanges may be coupled to a network backbone (for example, the public switched telephone network (PSTN), a packet-switched data network, or to other types of networks).

In another example, the connection 118 may be Wireless Fidelity (Wi-Fi, IEEE 802.11x type) connection, a Worldwide Interoperability for Microwave Access (WiMAX) connection, or another type of wireless data connection. In such an embodiment, the communication network 104 may include one or more wireless access points coupled to a local area network (LAN), a wide area network (WAN), the Internet, or other packet-switched data network.

In yet another example, the connection 118 may be a wired connection, for example an Ethernet link, and the communication network 104 may be a LAN, a WAN, the Internet, or other packet-switched data network. Accordingly, a variety of different configurations are expressly contemplated.

Turning specifically to the networked-based publisher 102, an application programming interface (API) server 120 and a web server 122 are coupled to, and provide programmatic and web interfaces respectively to, a plurality of servers 124. The application servers 124 host one or more identification module(s) 126, generation module(s) 128, transmission modules(s) 130. The plurality of servers 124 may be coupled via these interfaces to the communication network 104, for example, via wired or wireless interfaces. The plurality of servers 124 are, in turn, shown to be coupled to one or more database server(s) 132 that facilitate access to one or more databases) 134. In some examples, the plurality of servers 124 can access the database(s) 134 directly without the need for a database server 132.

An identification module 126 may be a hardware implemented module or software or instructions stored on a computer readable medium that is operable to identify a parcel based on an input received from the client device 106. In one embodiment, the identification module 126 may receive, as an input, a unique identifier that identifies the parcel. The unique identifier may be a number or other alpha numeric sequence. In some embodiments, the unique identifier may be a shipment tracking number corresponding to the parcel.

In another embodiment, the identification module 126 receives an AR enabled image transmitted from a client device (e.g., client device 106). In some embodiments, the AR enabled image may include a shipping label, a packing slip, or a parcel that may include one or more identification objects used to access interactive elements. In some embodiments, the identification object may be a textured object, such as, for example, a brick wall pattern. In other embodiments, the identification object may be an AR code, which may be used to identify the parcel and access one or more interactive elements. The AR code may be a barcode, QR code, or an alphanumeric sequence. In some embodiments, the identification object may be a shipment tracking number provided by the carrier.

In some embodiments, the identification module 126 performs image recognition techniques (e.g., edge detection, foreground segmentation, pattern matching) on the image to identify an identification object or aspects of the identification object contained within the image. To the extent necessary, the identification module 126 may enhance the attributes of the image to aid in the processing of the image. In some embodiments, the identification objects are markers in the image that aid the identification module 126 in processing of the image.

The identification module 126 may identify the parcel and one or more interactive elements based on the recognition of identification objects (e.g., texture objects, AR codes, and shipping tracking numbers) that identify the parcel, or interactive elements contained in the image. In some embodiments, the identification object may be a shared identifier that identifies a particular category or grouping of interactive elements. For example, the identification object may identify a grouping of interactive elements related to a merchant loyalty program such as interactive coupons or advertisements. In some embodiments, the identification object may be a shared identifier that identifies a set or parcels and one or more interactive elements related to the set. For example, the identification object may identify an interactive element to provide assembly instructions for a product with multiple components that were shipped in separate parcels.

According to some embodiments, the identification module 126 may generate a database 134 of identification objects corresponding to one or more parcels. In the event the identification module 126 does not identify a parcel, or interactive element, the identification module 126 may perform procedures to identify and store the identification object in the database 134. Such procedures may include prompting a user to provide additional information about the unknown identification object in the image, extracting Object attributes from the image containing the unknown identification object, accessing one or more external systems to look up and retrieve additional information related to the identification object, and so forth. For example, the user may be prompted to identify the object by manually inputting a unique identifier located on a shipping label.

A generation module 128 may be a hardware implemented module or software or instructions stored on a computer readable medium that is operable to generate presentation data (e.g., an augmented reality view) that is overlayable on a real time image of the parcel. For purposes of this disclosure and pertinent claims, the concept of an image that is “overlayable” shall refer to interactive content that may be over laid upon a real time image to provide an augmented reality experience. The real time image may be generated, for example, by a forward facing camera of client device 106.

In some embodiments, the presentation data is positioned over the image using the identified identification objects. The presentation data may include one or more interactive elements, and the presentation data may include one or more different views that may be generated depending on interactions with the interactive elements by the user. For example, a first interactive element may identify the sender of the parcel or aspects of an item contained in the parcel. In response to user input, in some embodiments, a second interactive element corresponding to a shipping confirmation of the parcel may be presented. In some embodiments, a third interactive element may identify one or more coupons, programs, or advertisements offered by a merchant associated with the parcel. The coupons, programs, and advertisements may be related to an item within the parcel (e.g., accessories) or other items offered by the merchant. In some embodiments, the interactive element may be a specialized message that is overlaid on the parcel.

A transmission module 130 may be a hardware implemented module or software or instructions stored on a computer readable medium that is operable to transmit a presentation to the client device 106. The transmission module 130 may also be configured to provide the client device 106 with instructions to overlay the presentation data over a real time image. In some embodiments, the transmission module 130 may also transmit a shipping confirmation notification over network 10.4 to another client device 108 or third party server 114. In some embodiments, the transmission module 130 may use Global Positioning System (GPS) data obtained from the client device 106 to include the location of the user in the notification.

Database server 132 may facilitate access one or more databases 134 and retrieve data for inclusion in the presentation data. The data may correspond to parcel shipping confirmation, specialized messages, merchant programs, coupons or advertisements, listings of products or related products offered for sale, and so forth. In some embodiments, the databases 134 may include databases both internal and external to the network-based publisher 102 and external.

Further, while the system 100 shown in FIG. 1 employs a client-server architecture, the present invention is of course not limited to such an architecture, and could equally well find application in a distributed, or peer-to-peer, architecture system, for example. The various modules of the plurality of servers 124 may also be implemented as standalone systems or software programs, which do not necessarily have networking capabilities.

FIG. 1 also illustrates a third party application 116 that may execute on a third party server 114 and may have programmatic access to the network-based publisher 102 via programmatic interface provided by the API server 120. For example, the third party application 116 may use information retrieved from the network-based publisher 102 to support one or more features or functions on a website hosted by the third party. The third party website may, for example, be a merchant website that may provide one or more functions that are supported by the relevant applications of the network system 100. In another example, the third party website may, for example, be a carrier service (e.g. United Parcel Service, Inc. (UPS), Federal Express (FedEx), United States Postal Service (USPS), or DHL Express) that may provide shipment tracking and confirmation functions to the network system 100.

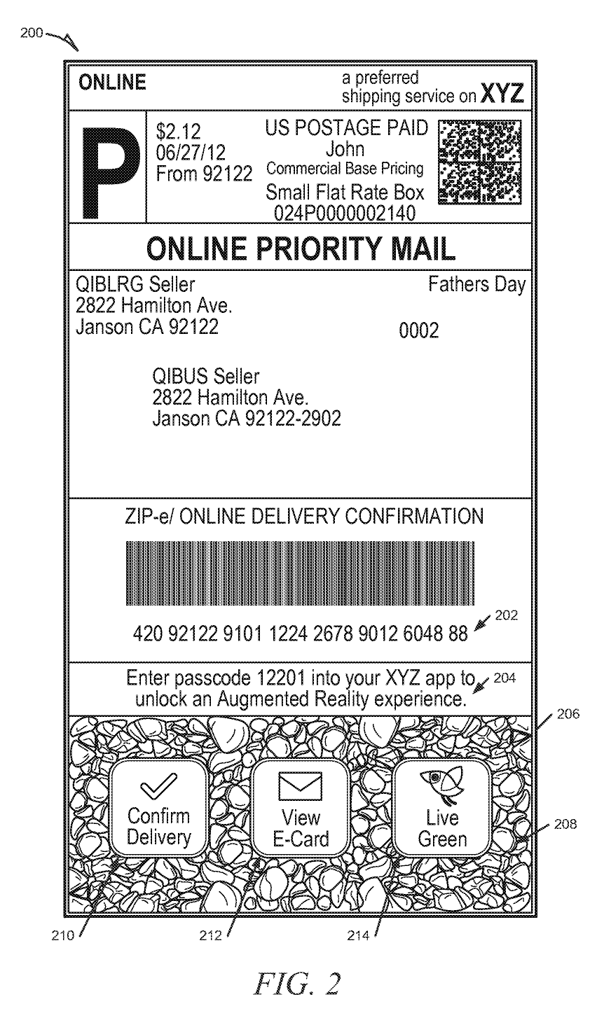

FIG. 2 is a diagrammatic representation of an example label 200 that may be used in providing augmented reality services to the recipient of a parcel, according to some embodiments. Although a shipping label is used in this embodiment to provide augment reality services, it should be appreciate that in other embodiments the AR enabled image may include any other item that may be associated with the parcel (e.g., packing slip, invoice or parcel packaging).

In this embodiment, the shipping label 200 may originate and be used with any package delivery company used to deliver a package (e.g. UPS, FedEx, USPS, or DHL Express). Online delivery confirmation number 202 is an identifier used by the package delivery company to track the package from its originating location to the final destination. Online delivery confirmation number 202 uniquely identifies the parcel and may be used to provide a user with a real-time tracking status update of the parcel. In some embodiments, identification module 126 may identify the parcel according to the online delivery confirmation number 202. According to this embodiment, once the parcel has been identified by the identification module 126, the generation module 128 may generate presentation data that is specific to that parcel.

In another embodiment, unique identifier 204 may be input by the user and used by the identification module 126 to uniquely identify the parcel and to provide presentation data that is specific to that parcel. In another embodiment, the identification module 126 may receive an image of the label and perform image recognition techniques (e.g., edge detection, foreground segmentation, pattern matching) on the image to identify the unique identifier contained within the image.

The augmented reality service interface 206 may be comprised of texture object 208 and buttons 210, 212, and 214. Buttons 210, 212 and 214 may each provide a separate distinct interactive element. It should be appreciated that buttons 210, 212, and 214 are provided by way of non-limiting example and that label 200 may contain any number of buttons, and any number of interactive elements, which may provide a number of augmented reality features. In one embodiment, the identification module 126 identifies the parcel and each interactive service provided by buttons 210, 212, and 214 by the online delivery confirmation number 202. In another embodiment, the identification module 126 identifies the parcel and each service provided by buttons 210, 212, and 214 by the unique identifier 204. In yet another embodiment, the identification module 126 identifies the parcel and each service provided by buttons 210, 212, and 214 by the texture object 208. The texture object 208 may also be used as markers in the image that aid the transmission module 130 in providing instructions to the client device 106 to overlay the presentation data of the real time image.

In some embodiments, a user may interact with the buttons 210, 212, and 214 through physical real-world interactions with the buttons perceived through the user interface of the client device of the user (e.g., client device 106). In other embodiments, a user may interact with the buttons 210, 212, and 214 through input from a client device 106 via an accelerometer, a touchscreen, a gesture capture, a stylus or a combination thereof. The generation module 128 may generate presentation data to enable a user to interact with buttons 210, 212, and 214 based on the configuration, location and number of buttons, as well as the recognition of the texture object 208. The generation module 128 may provide each interactive element provided by each of the buttons based on the information received from the identification module 126.

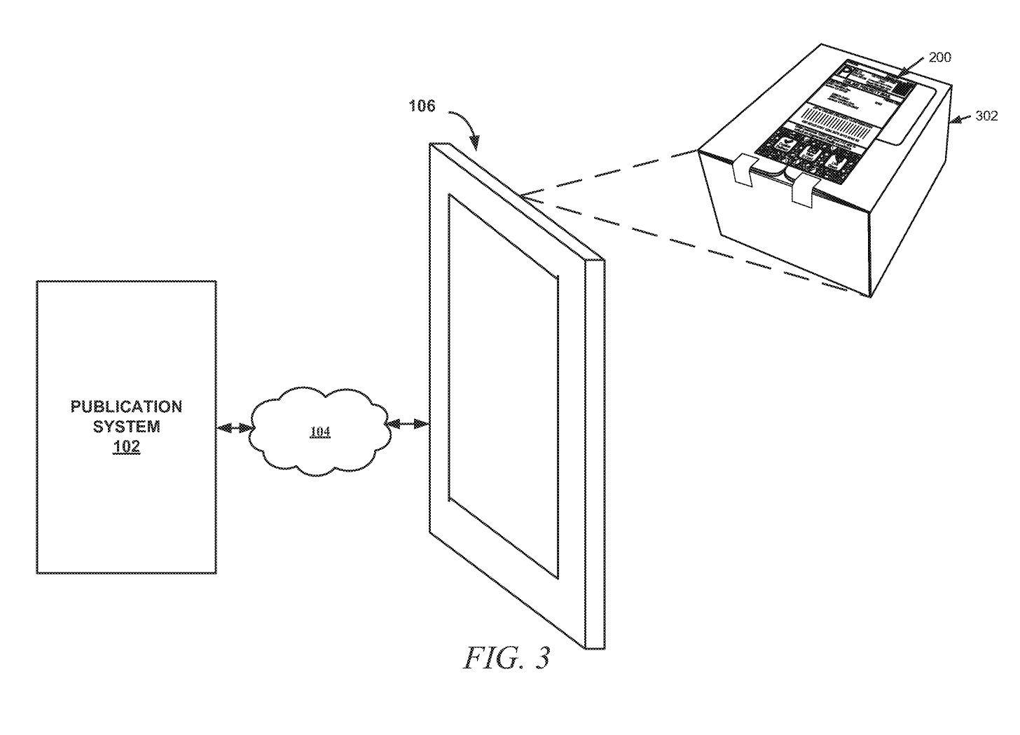

FIG. 3 is a diagrammatic representation of an example client device 106 in the form of a mobile tablet computer. Other client devices may include, but are not limited to, laptop computers and mobile phones (e.g. smart phones). In various embodiments, the client device 106 includes at least one processor, display, image capture device, network interface, and input device. The display may be a touchscreen or non-interactive display. In an embodiment, the image capture device is a camera. The network interface may be configured to transmit and receive on multiple frequencies (e.g., 4G, 3G, 802.11, etc.) over network 104 with publication system 102. The input device may be a keyboard, touchscreen, gesture capture, stylus or a combination thereof. In various embodiments, client device 106 also includes one or more applications that are executed by the at least one processor. The executed applications may be configured to perform the functions and methods described herein.

FIG. 3 also illustrates a parcel 302 having a shipping label with augmented reality services (e.g., label 200). Parcel 302 is illustrated in the physical real-world being received by a recipient user without any further interaction. In some embodiments, the forward facing camera of the client device 106 may capture an image of the parcel 302. The presentation data, including one or more interactive elements, that may be generated by the generation module 128 may then be overlaid on the image of the parcel 302 and presented in an augmented reality view on the display of the client device 106.

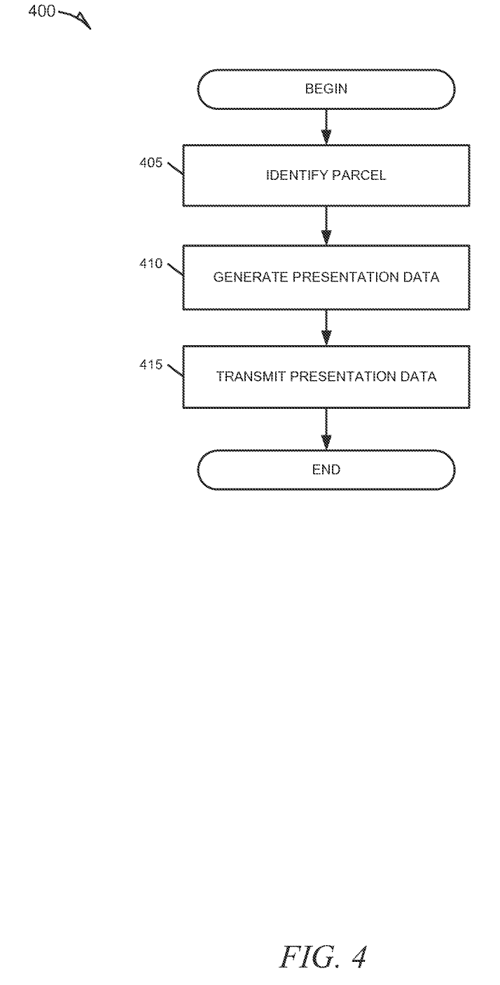

FIG. 4 is a flowchart illustrating an example method 400 for providing augmented reality enhanced shipping services, according to an example embodiment. In this example, the method 400 may include operation such as identifying a parcel 405, generating presentation data 410, and transmitting presentation data to client device 415.

At block 405, a parcel 302 is identified by the identification module 126 based on input received from a client device 106. In some embodiments, the input received from the client device 106 is a unique identifier of the parcel 302. In other embodiments, the user input is image data. In this embodiment, the identification of the input may include recognizing an identification object e.g., texture object or barcode) based on image data received from the client device 106.

At block 410, the generation module 128 may generate presentation data specific to the parcel 302. The presentation data may include content that is overlayable on a real time image of the parcel 302 captured using a camera included on client device 106. The content may include one or more interactive elements providing augmented reality features specific to the parcel 302. For example, the content may include an interactive element that enables a user to confirm shipping of the parcel 302. In another example, the content may include a specialized message for the recipient of the parcel 302 such as an electronic greeting card.

At block 415, the transmission module 130 may transmit the presentation data to the client device 106. The transmission module 130 may further instruct the client device 106 to overlay the presentation data over a real time image of the parcel 302. In various embodiments, the transmission module 130 determines the locations (e.g., position) of where to overlay the presentation data in the augmented reality space. In an embodiment, the placement information may be included in the presentation data by the generation module 128. In various other embodiments, the data is overlaid in a video of a parcel 302 having shipping label 200. The video may be a “live” view of the parcel 302 as a user is pointing the image capture device at the item.

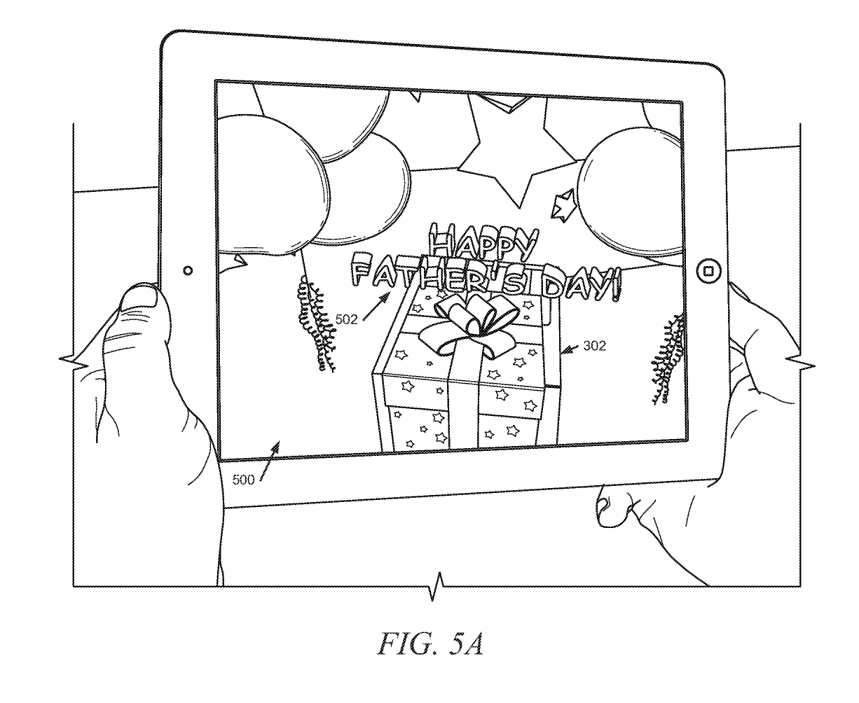

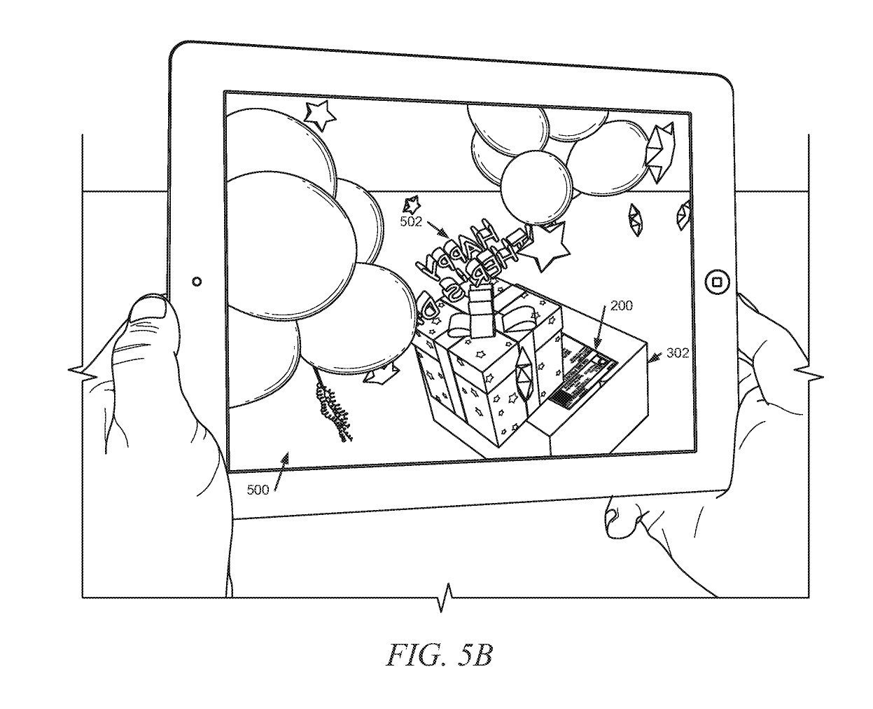

FIG. 5A is an interface diagram illustrating an example augmented reality service user interface 502 displaying a message to a parcel recipient, according to some embodiments. In this example, user interface 502 of client device 106 displays parcel 302 having label 200 in the augmented reality space having a specialized message 502 intended for the recipient of the parcel 302. In this example, the sender of the parcel 302 has enabled an interactive element to send the recipient of the gift parcel 302 an electronic greeting card with the message “Happy Fathers Day!” and some additional related content.

In some embodiments, to access the message, client device 106 is positioned over, or in close proximity to, the parcel 302 or the label 200. For example, in FIG. 5A, the parcel 302 is not visible because the parcel 302 is positioned directly behind the client device 106. The parcel recipient may view the parcel 302 on the client device 106 using a front-facing camera (not shown) located on the opposite side of the client device 106.

FIG. 5B is an interface diagram illustrating the example user interface 500 from FIG. 5A that has been updated based on further interaction from the user. In this example, the user has moved locations within the physical real-world space to obtain the rear perspective of the parcel 302. The parcel 302 can once again be seen through the user interface 500 of client device 106 having label 200. The rear perspective of the specialized message 502 and associated additional content can also been seen through the user interface 500.

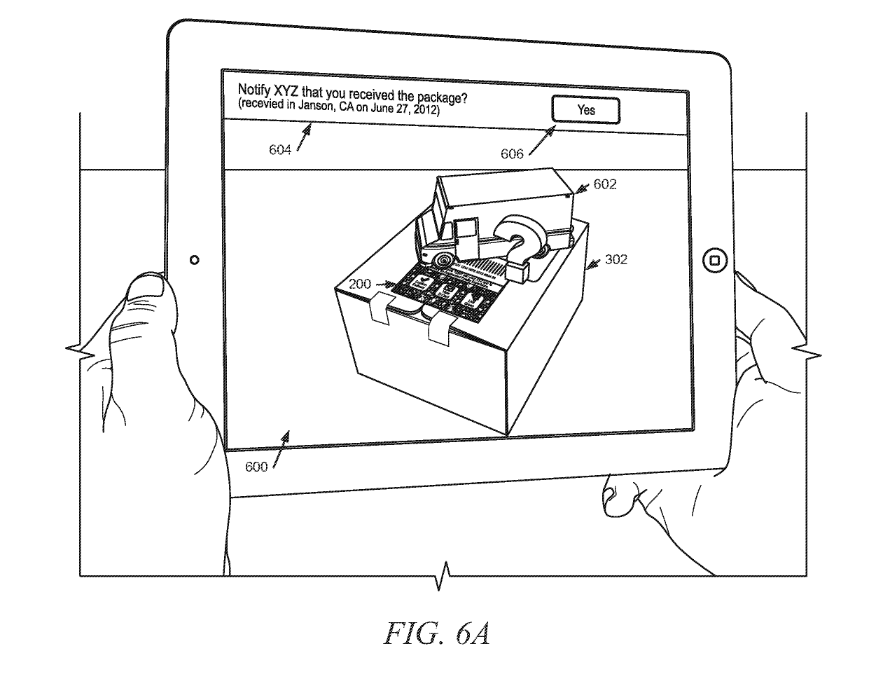

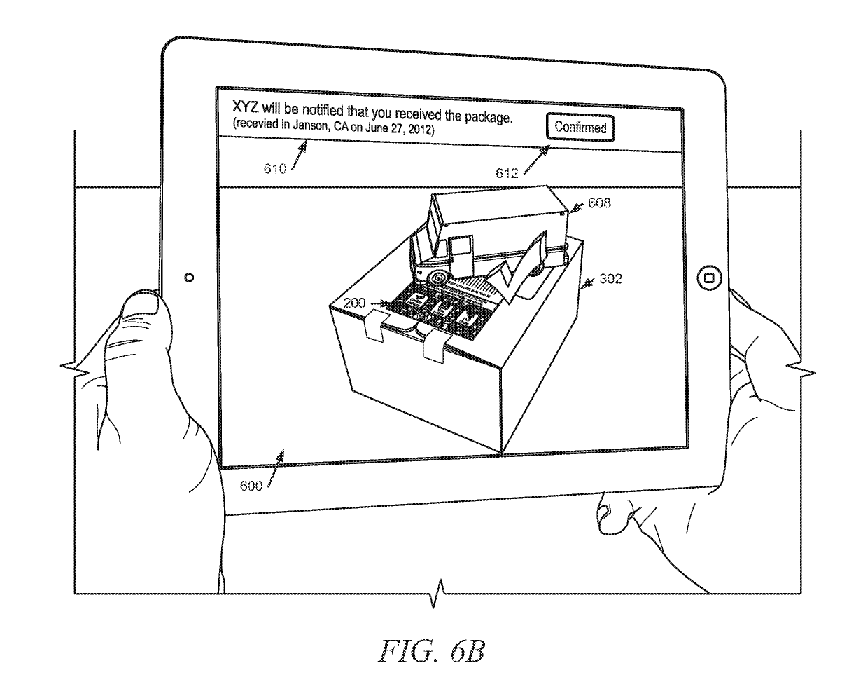

FIG. 6A is an interface diagram illustrating an example augmented reality service user interface 600 displaying a prompt for a user to confirm delivery. The user interface 600 displays a parcel (e.g., parcel 302) with a label having augmented reality services enabled (e.g. label 200). Interactive element 602 is displayed overlaid on top of the image of the parcel 302 to notify the user that confirmation of receipt of the parcel 302 has not yet occurred. Prompt 604 provides a message to the user regarding the confirmation of receipt of shipment as well as button 606 to allow the user to confirm shipping.

In one embodiment, the confirmation of delivery is sent to the merchant. In another other embodiment, the confirmation of delivery may be sent to person who purchased the item from the merchant. In other embodiments, the notification of delivery also includes a time stamp and the location of the package when delivery was confirmed.

FIG. 6B is an interface diagram illustrating the example user interface 600 from FIG. 6A that has been updated based on further interaction from the user. In this example, the user has confirmed delivery via button 606. Interactive element 608 appears nearly identical to interactive element 602 except that the question mark has been replaced by a check mark to indicate that delivery has been confirmed. Additionally, prompt 610 and button 612 provide further indication of the confirmation of delivery. Specifically, prompt 610 includes an indication of confirmation of delivery as well as the location of the user at the time of confirmation.

### Example Mobile Device

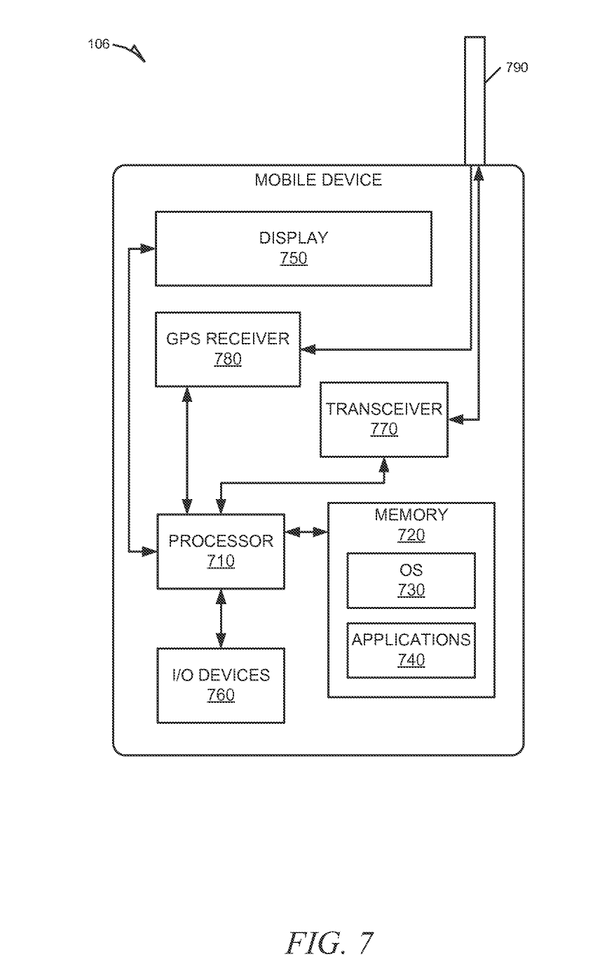

FIG. 7 is a block diagram illustrating a mobile device, according to an example embodiment. The client device 106 may include a processor 710. The processor 710 may be any of a variety of different types of commercially available processors suitable for mobile devices (for example, an XScale architecture microprocessor, a Microprocessor without Interlocked Pipeline Stages (MIPS) architecture processor, or another type of processor). A memory 720, such as a Random Access Memory (RAM), a Flash memory, or other type of memory, is typically accessible to the processor. The memory 720 may be adapted to store an operating system (OS) 730, as well as application programs 740, such as a mobile location enabled application that may provide augmented reality services to a user. The processor 710 may be coupled, either directly or via appropriate intermediary hardware, to a display 750 and to one or more input/output (I/O) devices 760, such as a keypad, a touch panel sensor, a microphone, camera, and the like. Similarly, in some embodiments, the processor 710 may be coupled to a transceiver 770 that interfaces with an antenna 790. The transceiver 770 may be configured to both transmit and receive cellular network signals, wireless data signals, or other types of signals via the antenna 790, depending on the nature of the client device 106. In this manner, the connection 118 with the communication network 104 may be established. Further, in some configurations, a GPS receiver 780 may also make use of the antenna 790 to receive GPS signals.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network 104 (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

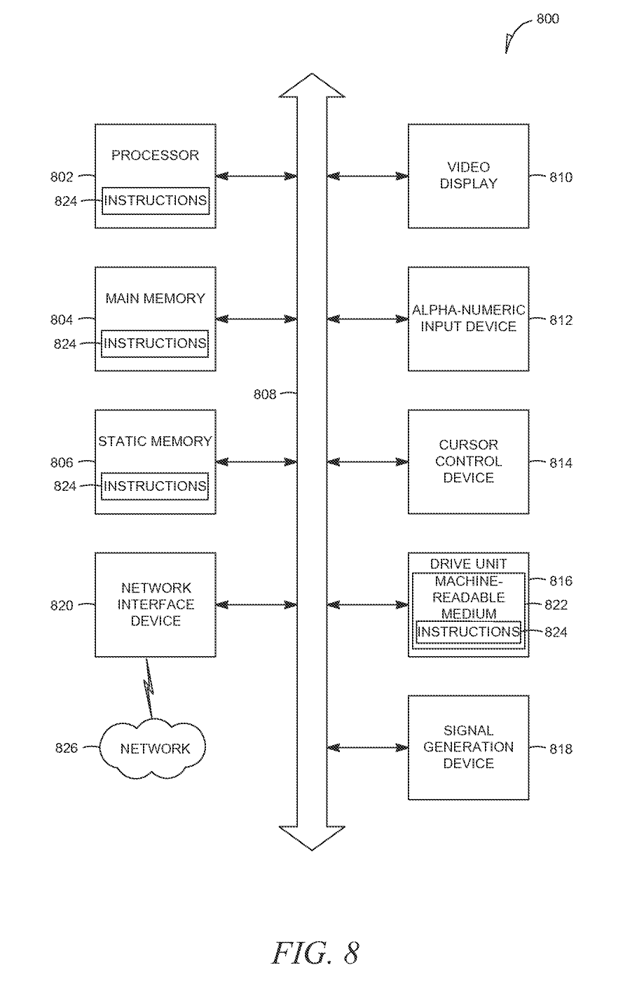

FIG. 8 is a block diagram of machine in the example form of a computer system 800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein,

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a disk drive unit 816, a signal generation device 818 (e.g., a speaker) and a network interface device 820.

### Machine-Readable Medium

The disk drive unit 816 includes a machine-readable medium 822 on which is stored one or more sets of instructions and data structures (e.g., software) 824 embodying or used by any one or more of the methodologies or functions described herein. The instructions 824 may also reside, completely or at least partially, within the main memory 804, static memory 806, and/or within the processor 802 during execution thereof by the computer system 800, the main memory 804, static memory 806 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof show by way of illustration and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
an identification module to identify a parcel based on an input received from a user device;
a generation module to generate presentation data specific to the parcel, the presentation data including one or more interactive elements;
a transmission module to transmit presentation data to the user device and to instruct the user device to overlay the presentation data over a real time image of the parcel.

2. The system of claim 1, wherein the one or more interactive elements are indicated on a shipping label on the parcel.

3. The system of claim 2, wherein the input received from the user is an image of the shipping label.

4. The system of claim 3, wherein the identifying of the parcel is based on recognition of an object contained on the shipping label.

5. The system of claim 1, wherein the input received from the user is an alpha numeric sequence.

6. The system of claim 1, wherein the interactive element allows the user to confirm the receipt of the parcel.

7. The system of claim wherein the interactive element is a message.

8. The system of claim 7, wherein the message is specific to an intended recipient of the parcel.

9. The system of claim 7, wherein the message includes an advertisement, special promotion, or coupon of a merchant.

10. The system of claim 7, wherein the message is an electronic greeting card.

11. A method comprising:
identifying a parcel based on input received from a user device;
generating presentation data specific to the parcel, the presentation data including one or more interactive elements;
transmitting presentation data to the user device; and
instructing the user device to overlay the presentation data over a real time image of the parcel.

12. The method of claim 11, wherein the user input is a shipment tracking number.

13. The method of claim 11, further comprising:
generating, in response to an additional user input, updated presentation data specific to the parcel;
transmitting the updated presentation data to the user device; and
instructing the user device to overlay the updated presentation data over the real time image of the parcel.

14. The method of claim 11, further comprising confirming receipt of the parcel in response to a user interaction with the one or more interactive elements that provide an option to confirm receipt of the parcel.

15. The method of claim 14, further comprising providing a notification that the parcel has been received to a sender of the parcel.

16. The method of claim 15, wherein the notification includes a location where the parcel was received.

17. The method of claim 1, further comprising providing the user with a message in response to a user interaction with the one or more interactive elements.

18. The method of claim 14, wherein the message includes an advertisement, special promotion, or coupon of a merchant who shipped the parcel.

19. The method of claim 18, wherein the message is an electronic greeting card.

20. A non-transitory machine-readable medium embodying instructions that, when executed by a machine, cause the machine to perform operations comprising:
an identification module to identify a parcel based on an input received from a user device;
a generation module to generate presentation data specific to the parcel, the presentation data including one or more interactive elements;
a transmission module to transmit presentation data to the user device and to instruct the user device to overlay the presentation data over a real time image of the parcel.
